(19) United States
(12) Patent Application Publication
(10) Pub. No.: US 2011/0226291 A1
(43) Pub. Date: Sep. 22, 2011

(54) FILTER CLEANING DEVICE

(76) Inventor: Perry Toussaint, Hellevoetsluis (NL)

(21) Appl. No.: 13/121,568

(22) PCT Filed: Sep. 1, 2009
(86) PCT No.: PCT/NL09/00168

§ 371 Date: Mar. 29, 2011

(30) Foreign Application Priority Data
Aug. 14, 2008 (NL) 2001890

(51) Int. Cl. B01D 41/04

(52) U.S. Cl. 134/157

(57) ABSTRACT

A device has a housing with a spindle installed therein. A carrier can be rotated around this spindle while moving along it. There are two nozzles installed in the cylinder wall of the device, which nozzles comprise a connecting piece to which a water hose can be connected. For having the water jet rotate a carrier-mounted filter the nozzle openings seen in axial direction of the spindle, are directed at the filter beside the spindle.

### FIELD OF THE INVENTION

The invention relates to a filter cleaning device. The invention more particularly relates to a device for cleaning a cartridge filter which is frequently used in a bubble bath and/or massage bath, in a swimming pool or in a pond.

### STATE OF THE ART

A device of this type is generally known. The known device comprises a relatively large number of nozzles arranged in a row which are squirting water around a slowly rotating filter. During this operation the filter is not hit equally well throughout by the water jet. A disadvantage of the known device is that the filter is not cleaned equally well in all places. Close to the nozzles the filter is cleaned better than midway between two nozzles. Furthermore, the resulting fouled water is not collected. When the bubble bath and/or massage bath is used at regular intervals the filter should be cleaned at least once a week. Since dirt and water fly anywhere during this operation when the known device is used, the cleaning should be performed out of doors. Since bubble baths and/or massage baths are particularly used in winter, the cleaning of the filter is an unpleasant activity. Moreover, proper cleaning of such a filter with the known device costs relatively much water and takes up relatively much time.

### SUMMARY OF THE INVENTION

It is an object of the invention to provide a filter cleaning device with which a filter can be cleaned in a simple and efficient manner. For this purpose the device comprises a spindle with a threaded support disposed thereon on which support a filter can be mounted, which support can be rotated around the spindle and when rotated moves along the spindle, the device further including a nozzle with a nozzle opening which is directed at the filter when a filter is accommodated on the support. The filter to be cleaned is to be mounted on the support and a water hose is to be connected to the nozzle. As a result of gravity and/or as a result of the force of the water jet the filter starts rotating around the spindle off centre of the filter and then moves along the spindle during which operation all parts of the filter move past the water jet. As a consequence of centrifugal force the water is slung away from the filter, so that the dirt is discharged extra well indeed. By means of the device according to the invention a filter is cleaned in a brief period of time and with less water than when the filter is cleaned by hosing it down.

In order not to spray the dirt into the filter, but just away from the filter, the nozzle is preferably directed at an angle to the longitudinal direction of the spindle.

In order to have the filter rotate by the water jet, in an embodiment of the device according to the invention the nozzle opening, seen in axial direction of the spindle, is directed beside the spindle. So the water jet is not directed at the centre of the filter, but off centre of the filter. As a result of this the water jet will cause the filter to rotate around the spindle.

For a better cleaning of the filter a further embodiment of the device according to the invention is characterised in that the device further includes a further nozzle with a further nozzle opening which, seen in axial direction of the spindle, is also directed beside the spindle, the spindle, seen in a direction at right angles to the spindle, being disposed in between the two nozzles. By first connecting the water hose to the one nozzle, the filter will turn one way and will move for example from bottom to top along the spindle. By subsequently connecting the water hose to the other nozzle, the filter will turn the other way and will move from top to bottom. As a result, the filter will be hosed down twice and the support will have returned to its initial position at the end of the cleaning operation.

Preferably, the nozzle opening of the further nozzle is directed at a further angle to the longitudinal direction of the spindle with the nozzle openings of the nozzles being directed away from each other.

A still further embodiment of the device according to the invention is characterised in that the device comprises a housing which is open at the top and is covered by a cover and at the bottom has a discharge opening, the spindle being attached to the bottom of the housing and the nozzles being installed in the side wall of the housing. As a result, the device can be used indoors, so that it is no longer necessary to carry out the filter cleaning operation out of doors in the cold.

### BRIEF DESCRIPTION OF THE DRAWING FIGURES

The invention will be further described below in more detail with reference to an embodiment of the device according to the invention represented in the drawing figures, in which:

FIG. 1 shows a longitudinal section of an embodiment of the device according to the invention; and

FIG. 2 shows a cross section of the device.

### DETAILED DESCRIPTION OF THE DRAWINGS FIGURES

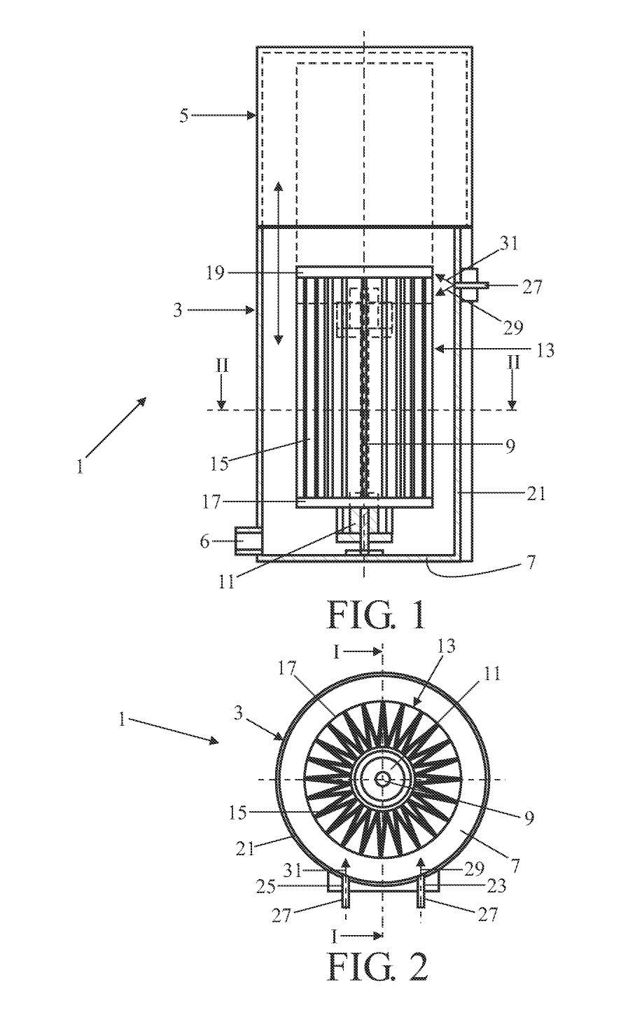

FIGS. 1 and 2 show a longitudinal section and a cross section respectively of an embodiment of the device for cleaning filters. The device 1 has a cylindrical housing 3 which is open at the top and is closed by a cover 5 and at the bottom has a discharge opening 6. At the bottom 7 of the housing is mounted a spindle 9 around which an internally threaded support 11 can be turned which moves along the spindle when turning. The support carries a filter 13. The filter is a filter comprising a zigzag-shaped filter plate 15 installed in a circle and at the axial ends is enclosed between a plate 17 and an annulus 19.

There are two nozzles 23 and 25 installed in the cylinder wall 21 of the device 1. Each nozzle has a connecting piece 27 to which a water hose can be connected. For hosing down the filter 13 the nozzle openings of the nozzles 23 and 25 are installed at a 60 degree angle to the longitudinal direction of the spindle 9 (see FIG. 1). As a consequence of this the water jets 29 and 31 leaving the nozzles are directed upwards and downwards with the nozzle opening 29 of nozzle 23 being directed 30 degrees downwards and the nozzle opening 31 of the nozzle 25 being directed 30 degrees upwards. The angle of the nozzles is chosen such that in the top position of the filter the water jet 29 active thus far no longer hits the filter (as a result of the speed the filter has turned just a little further so that it is out of reach of the water jet). In this top position the water jet 31 is directed at the filter after the hose has been connected to the nozzle 25, so that the filter is again turned downwards.

For having the water jet rotate the filter 13 rotate, the nozzle openings 29, 31, seen in axial direction of the spindle, are directed at the filter beside the spindle 9 (see FIG. 2).

For cleaning a filter 13, the filter is to be placed onto the carrier 11 and a water hose is first to be connected to nozzle 23. As a result of the force of the water jet 29 the filter 13 starts rotating around the spindle while the filter moves upwards along the spindle 9 in a rotating fashion (the filters are to be cleaned from top to bottom) as far as the position indicated in the drawing FIG. 1 by means of broken lines. All parts of the filter then pass by the water jet during this operation. Then the water hose is connected to nozzle 25 as a result of which the filter will move downwards in rotating fashion. Now the filter is hosed down a second time and the carrier 11 will return to its initial position.

Albeit the invention has been described in the foregoing based on the drawing figures, it should be observed that the invention is not by any manner or means restricted to the embodiment shown in the drawing figures. The invention also extends to all embodiments deviating from the embodiment shown in the drawing figures within the spirit and scope defined by the claims.

1. A cleaning device for cleaning a filter, the cleaning device comprising:
a spindle with a threaded support disposed thereon on which the filter can be mounted, which threaded support can be rotated around the spindle and when rotated is displaced along the spindle; and
a nozzle with a nozzle opening which is directed at the filter when the filter is mounted on the support.

2. The device of claim 1, wherein the nozzle opening is directed at an angle to the longitudinal direction of the spindle.

3. The device of claim 1, wherein the nozzle opening, seen in axial direction of the spindle, is directed beside the spindle.

4. The device of claim 2, further comprising a further nozzle with a further nozzle opening which, seen in axial direction of the spindle, is also directed beside the spindle, the spindle, seen in a direction at right angles to the spindle, being disposed in between the two nozzles.

5. The device of claim 2, wherein the nozzle opening of the further nozzle is directed at a further angle to the longitudinal direction of the spindle with the nozzle openings of the nozzles being directed away from each other.

6. The device of claim 1, further comprising a housing which is open at a top, the open top being closed by a cover, and at a bottom has a discharge opening while the spindle is attached to the bottom of the housing and the nozzles are installed in the side wall of the housing.

7. A cleaning device for cleaning a filter, the cleaning device comprising:
a spindle with a threaded support disposed thereon on which the filter can be mounted, which threaded support can be rotated around the spindle and when rotated is displaced along the spindle;
a nozzle with a nozzle opening which is directed at the filter when the filter is mounted on the support; and
wherein the nozzle opening is directed at an angle to the longitudinal direction of the spindle.
